(19) United States
(12) Patent Application Publication
(10) Pub. No.: US 2005/0144045 A1
(43) Pub. Date: Jun. 30, 2005

(54) System and method to reduce insurance premiums

(76) Inventor: Jerome R. Corsi, Denville, NJ (US)

Correspondence Address: HAHN LOESER & PARKS, LLP, One GOJO Plaza, Suite 300, AKRON, OH, 44311-1076, US

(21) Appl. No.: 10/970,669

(22) Filed: Oct. 21, 2004

Related U.S. Application Data
(60) Provisional application No. 60/513,678, filed on Oct. 23, 2003.

(51) Int. Cl. G06F 17/60

(52) U.S. Cl. 705/4

(57) ABSTRACT

A system and method are disclosed to reduce insurance premiums for clients participating in a plan administered by an operating business entity. The method includes facilitating the establishment of a collateral account in the name of a client as part of the administered plan. The method further includes facilitating the purchasing of an insurance policy of a first type, having a premium payment and a deductible, in the name of the client, wherein the insurance policy of the first type is provided by an insurer approved by the operating business entity. The method also includes facilitating the pledging of the collateral account to payment of the deductible in the event of a successful claim against the client which is covered by the insurance policy of the first type. A computer-based system, having at least one processor and at least one memory module, may be used by an operator to help perform the various method steps.

### CROSS-REFERENCE TO RELATED APPLICATIONS/INCORPORATION BY REFERENCE

This application claims priority to provisional U.S. patent application Ser. No. 60/513,678, filed on Oct. 23, 2003, which is incorporated herein by reference in its entirety.

### TECHNICAL FIELD

Certain embodiments of the present invention relate to a system and method to facilitate doing business. More particularly, certain embodiments of the present invention relate to a system and method for reducing insurance premiums for the holders of insurance policies.

### BACKGROUND OF THE INVENTION

The cost of certain types of insurance for certain types of policy holders can be very high. Typically, the cost can be reduced by having or increasing a deductible on the insurance policy. The various types of insurance policies may include, for example, medical malpractice, automobile, homeowners, health, legal malpractice or other professional malpractice insurance, etc. For example, costs of medical malpractice insurance for physicians (i.e., licensed medical doctors) with good prior claims experience (i.e., no or few, according to malpractice insurance provider standards, malpractice claims successfully pursued against a physician) in states such as Ohio, for example, currently range from a low of approximately $30,000 per year in low risk medical specialties to a high of approximately $200,000 or more per year in high risk specialties. Physicians who can afford to pay insurance deductibles of around $100,000 per claim may obtain discounts of 15%-20% on the cost of their medical malpractice insurance (i.e., premium payments). However, insurers are reluctant to allow high deductibles unless physicians can commit sufficient collateral to make payment of the deductible certain in the event of a claim.

Also, insurers desire to have deductible payments made immediately and are often not interested in being in the business of having to liquidate the assets of an insured person in order to get a deductible paid.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

A first embodiment of the present invention comprises a method to reduce insurance premiums for a client participating in a plan administered by a separate operating business entity. The method comprises facilitating the establishment of a collateral account in the name of the participating client as part of the administered plan and facilitating the purchasing of an insurance policy (e.g., a medical malpractice insurance policy), having a premium payment and a deductible, in the name of the participating client. The insurance policy is provided by an approved insurer of the administered plan. The method further comprises facilitating the pledging of the collateral account to payment of the deductible in the event of a “successful” claim against the client which is covered by the first insurance policy.

A second embodiment of the present invention comprises a method to establish a collateral account in the name of a client participating in a plan administered by an operating business entity. The method includes obtaining a standby letter of credit from a financial institution in the name of the client and purchasing a first insurance policy, in the name of the client, having a cash value and a death benefit. The method further includes associating the standby letter of credit and the first insurance policy with a collateral account being in the name of the client and being pledged for payment of a deductible on a second insurance policy of the client.

A third embodiment of the present invention comprises a system to help administer a plan of an operating business entity to reduce insurance premiums. The system comprises a computer-based platform having at least one processor and at least one memory module. The system further comprises first information being stored in the at least one memory module, wherein the first information is associated with at least one client participating in the administered plan. The system also includes second information being stored in the at least one memory module, wherein the second information is associated with at least one collateral account being in the name of the at least one client participating in the administered plan. The system further includes third information being stored in the at least one memory module, wherein the third information is associated with at least one insurer of a first type that is approved by the operating business entity. The system further comprises at least one software module being stored in the at least one memory module and being executed on the at least one processor to process at least the first, second, and third information as part of implementing at least one method associated with the administered plan.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a flowchart of a method to reduce insurance premiums for a client participating in a plan administered by an operating business entity, in accordance with an embodiment of the present invention.

FIG. 2 illustrates a flowchart of a method to establish a collateral account in the name of a client participating in a plan administered by an operating business entity as part of the method of FIG. 1, in accordance with an embodiment of the present invention.

FIG. 3 is a functional illustration of an embodiment of a system to help administer a plan of an operating business entity to reduce insurance premiums, in accordance with various aspects of the present invention, including the methods of FIG. 1 and FIG. 2.

### DETAILED DESCRIPTION OF THE INVENTION

In accordance with an embodiment of the present invention, an operating business entity provides an administered plan where the plan participants may include clients (e.g., physicians), insurance providers of a first type (e.g., medical malpractice insurance providers), financial institutions (e.g., banks), and insurance providers of a second type (e.g., life insurance providers). The administered plan encourages the reduction of premiums (payments on an insurance policy) by facilitating the purchasing of insurance having a sizeable deductible on each participating client's insurance policy. Insurance of a first type (e.g., medical malpractice insurance) is purchased by the clients from the approved insurers of a first type (e.g., medical malpractice insurers). The discount on the premium comes from the ability to establish the deductible.

In the administered plan established by the operating business entity, a collateral account is established in the name of each client participating in the administered plan, in accordance with an embodiment of the present invention. Each client's collateral account is pledged to the payment of the deductible on his/her corresponding insurance policy of a first type (e.g., a medical malpractice insurance policy) in the event of a “successful” claim against a corresponding client (i.e., where a legitimate authority determines that a claim is successful and is, therefore, to be paid). A legitimate authority may be the insurance provider or a court, for example. The operating business entity may help facilitate the establishment and pledging of the collateral account as part of the administered plan, in accordance with an embodiment of the present invention.

In accordance with an embodiment of the present invention, the collateral account may comprise, for example, a first asset comprising a standby bank letter of credit as one source of funds from which a deductible payment can be immediately made. For each client in the plan, a standby letter of credit is established, in the name of the client, with a financial institution (e.g., a bank) that is approved by the operating business entity. The standby letter of credit belongs to the client and each client in the plan applies to a financial institution to qualify for the standby letter of credit. The operating business entity may help facilitate the establishment of the standby letter of credit as part of the administered plan. The client is also responsible for paying any fee charged by the financial institution for the standby letter of credit. When a deductible is to be paid, the funds go from the bank to the physician, in accordance with an embodiment of the present invention. In alternative embodiments of the present invention, the operating entity may act as an escrow agent for the funds, or the funds may go directly from the bank to the insurer.

In accordance with an embodiment of the present invention, a second asset in the collateral account may be, for example, an individually issued life insurance policy in the name of the client which is purchased by the client. Alternatively, the life insurance policy may be purchased by someone other than the client. The cash value of the life insurance policy is available as a second source of deductible payment. The death benefit of the life insurance policy serves as an ultimate source of repayment on any financed funds drawn from the collateral account that remain unpaid in the event of the client's death. The operating business entity may help facilitate the establishment of the life insurance policy as part of the administered plan. The life insurance policy is held in collateral assignment to the financial institution (e.g., an approved bank) as part of the collateral account. In accordance with an embodiment of the present invention, the life insurance policy may be a whole life policy or similar vehicle that is structured to emphasize cash value build-up. In accordance with an alternative embodiment of the present invention, the life insurance policy may also serve as collateral for the standby letter of credit.

In accordance with an embodiment of the present invention, the operating business entity administers the plan but does not take on any liability for the clients or for payment of the deductible. The operating business entity is simply an administrator of the plan and is not in an “at risk” position. In accordance with an embodiment of the present invention, the operating business entity comprises a licensed life insurance agency and generates revenue for the business entity by sharing a commission with the life insurance policy provider. Commissions may include initial first year commissions as well as renewal commissions. The operating business entity may also charge an application fee to clients who apply to participate in the administered plan. In accordance with an alternative embodiment of the present invention, the operating business entity may comprise a non-profit medical association.

In accordance with an embodiment of the present invention, the administrative duties of the operating business entity comprise various types of underwriting and screening of clients. For example, financial underwriting of clients may be performed to help qualify clients for standby letters of credit. Credit checks (e.g., obtaining and reviewing credit reports) may also be performed. Medical underwriting may be performed to help qualify clients for life insurance. Clients are screened to determine their insurance history as part of a process to select clients for the plan. For example, physicians may be screened to determine their medical malpractice history as part of a process to select physicians for the plan. Also, the current status of participating clients is monitored to determine if a client should be retained in the plan or dropped from the plan.

Other possible duties of the operating business entity may include working with the life insurance providers to design whole life, universal life, or other life insurance policies that emphasize cash value build-up and to generate formulas to determine various whole life parameter relationships such as, for example, death benefit versus premium payment. Also, the operating business entity may develop and update a specification for the standby letter of credit which the financial institutions (e.g., the banks) will have to comply with. The specification may define, for example, the criteria for making a claim, how a deductible payment check gets issued, and how the bank works with a client to qualify the client for the standby letter of credit.

To preserve the solvency of the administered plan, each client in the plan may be charged back all or a portion of each deductible paid from the collateral account. In accordance with an embodiment of the present invention, a charge back to a participating client may be ½ of the deductible on a first claim, ⅔ of the deductible on a second claim, and 100% of the deductible on a third claim. If, however, the deductible payment comes entirely from the standby letter of credit, the charge back, in all cases, may be 100% of the funds advanced. The charging back may be facilitated by the operating business entity as part of the administered plan, in accordance with an embodiment of the present invention.

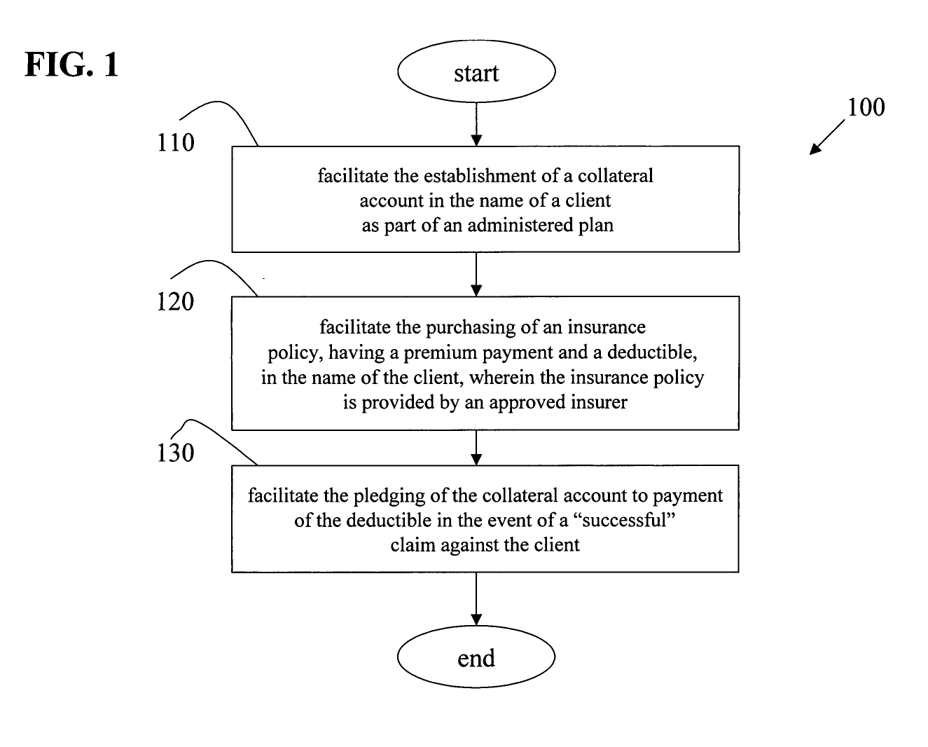

FIG. 1 illustrates a flowchart of a method 100 to reduce insurance premiums for a client participating in a plan administered by an operating business entity, in accordance with an embodiment of the present invention. In step 110, the establishment of a collateral account in the name of the client is facilitated as part of the administered plan. In step 120, the purchasing of an insurance policy, having a premium payment and a deductible, in the name of the client is facilitated, wherein the insurance policy is provided by an approved insurer of the administered plan. In step 130, the pledging of the collateral account to payment of the deductible in the event of a successful claim against the client is facilitated.

In accordance with an embodiment of the present invention, the client may be charged back all or part of the deductible if the deductible is paid from the collateral account. The charge back may be facilitated by the operating business entity. In accordance with an alternative embodiment of the present invention, the paid deductible may not be charged back to the client if, for example, the collateral account contains sufficient funds from other personal assets of the client.

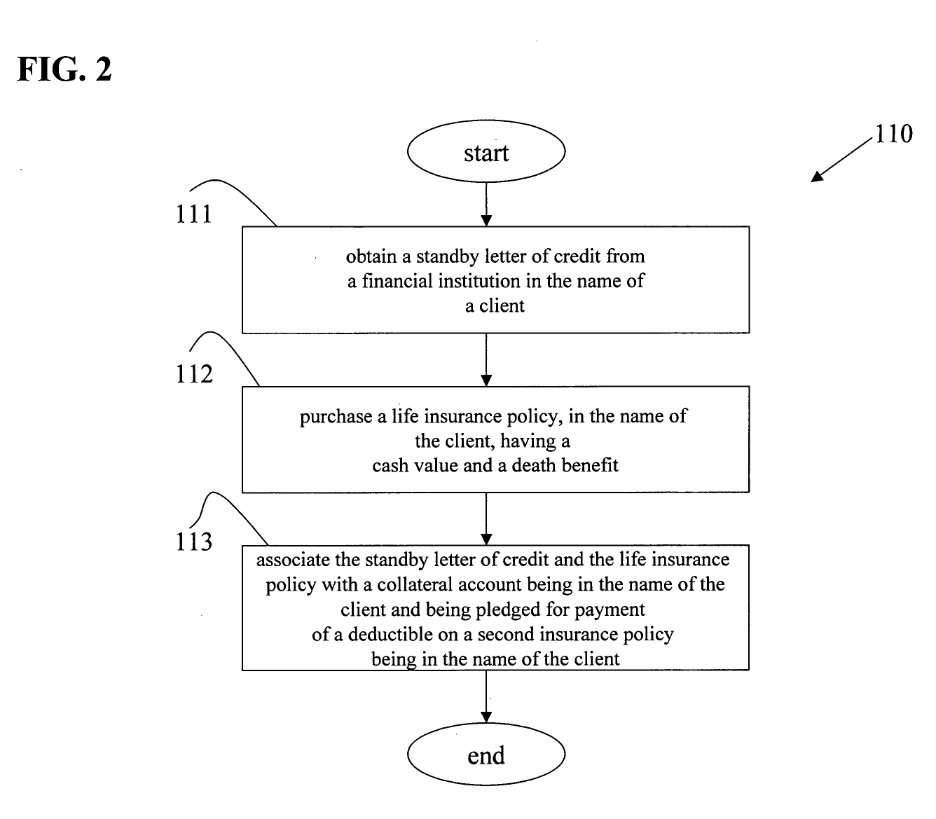

FIG. 2 illustrates a flowchart of a method 110 to establish a collateral account in the name of a client participating in a plan administered by an operating business entity as part of the method of FIG. 1, in accordance with an embodiment of the present invention. In step 111, a standby letter of credit is obtained from a financial institution in the name of the client. In step 112, a life insurance policy is purchased, in the name of the client, having a cash value and a death benefit. In step 113, the standby letter of credit and the life insurance policy are associated with a collateral account being in the name of the client and being pledged for payment of a deductible on a second insurance policy being in the name of the client. In accordance with alternative embodiments of the present invention, the collateral account may include cash provided by the client or real-estate provided by the client, for example. Other assets for collateral are possible as well.

As an example, a collateral account may be established for a participating physician which includes a standby letter of credit for $100,000 and a whole life insurance policy with a current cash value of $100,000 and a death benefit of $500,000. The standby letter of credit is obtained by the participating physician from a bank and the life insurance policy is obtained by the participating physician from a life insurance provider. The life insurance policy is held in collateral assignment by the bank. The operating business entity, which administers the plan and is a licensed life insurance agent, helps to facilitate the establishment of the collateral account with the standby letter of credit and the life insurance policy.

Next, the participating physician, with the help of the operating business entity, purchases a medical malpractice insurance policy having a per claim deductible of $100,000. The conditions of the purchase are such that the collateral account is pledged to the payment of the $100,000 deductible in the event of a “successful” malpractice claim against the participating physician.

When a malpractice claim for, for example, $300,000 is successful against the participating physician, the business entity helps to facilitate the transfer of the deductible amount of $100,000 from the collateral account to the malpractice insurer. The $100,000 amount may be transferred, based on the standby letter of credit, to the participating physician, and from the participating physician to the approved malpractice insurer. As a result, the approved malpractice insurer gets its deductible very quickly. As an alternative, a physician may elect to pay the deductible directly from separate funds in order to avoid any finance charges or other charges associated with using the letter of credit.

Finally, the participating physician is charged back the $100,000 deductible that was paid from the collateral account (i.e., the physician owes the $100,000 back to the bank). As a result, the physician chooses to cash in the life insurance policy held in the collateral account for the current cash value of $100,000 and pays back the bank. The participating physician may then, for example, opt out of the administered plan, or replenish the letter of credit from other outside resources.

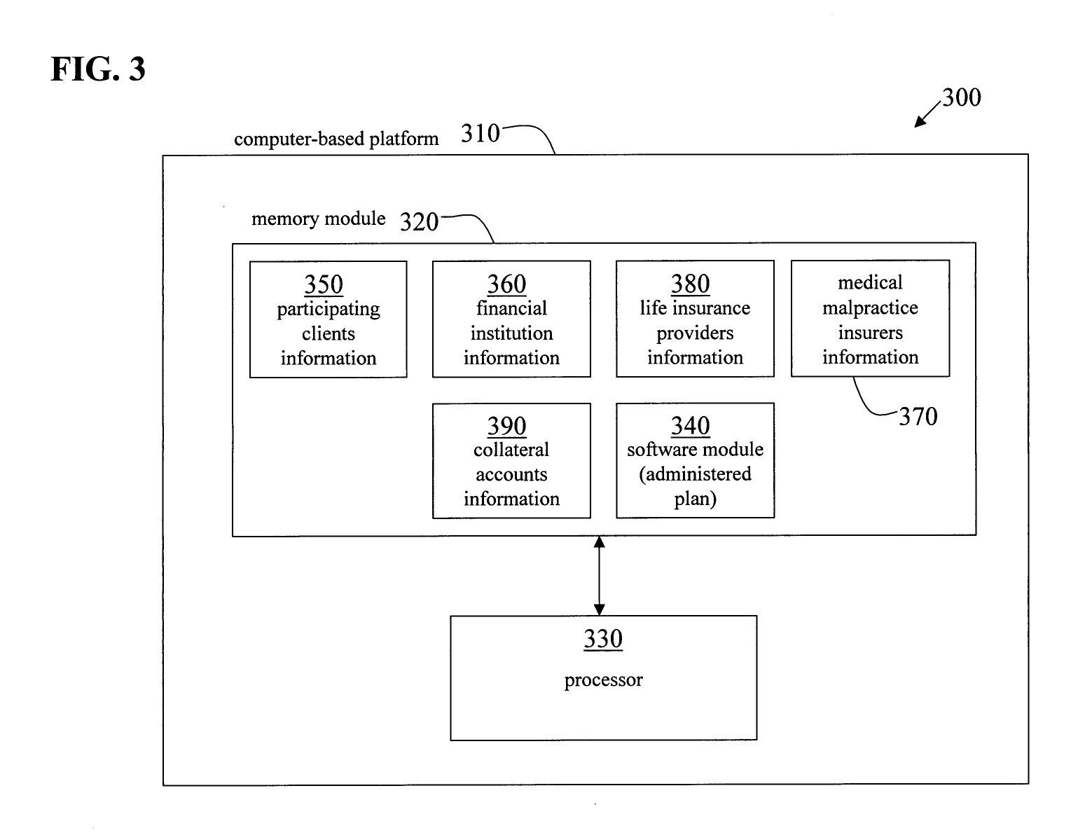

FIG. 3 is a functional illustration of an embodiment of a system 300 to help administer a plan of an independent operating business entity to reduce insurance premiums, in accordance with various aspects of the present invention, including the methods of FIG. 1 and FIG. 2. The system 300 comprises a computer-based platform 310 such as a personal computer or a main-frame computer, for example. The system 300 includes at least one memory module 320 and at least one processor 330. The memory module stores at least one software module 340 which is executed on the at least one processor 330 to implement the methods, in whole or in part, of at least FIG. 1 and FIG. 2 and to process various information stored in the at least one memory module 320 related to the administered plan.

The software module 340 may provide database functions, algorithmic functions, and any other type of functionality associated with the administered plan. The various information stored in the at least one memory module 320 includes participating clients information 350, financial institution information 360, insurers of a first type information 370, insurers of a second type information 380, and collateral accounts information 390.

As an example, the clients may be physicians, the insurance providers of the first type may be medical malpractice insurers, and the insurance providers of the second type may be life insurance providers. Information of a newly accepted participating physician may be entered by an operator into the computer-based platform 310 as part of a file in a database associated with the participating physicians information 350. The operator may then facilitate the establishment of a collateral account for the newly accepted participating physician by commanding the software module 340 to set up a new collateral account file in a database associated with the collateral accounts information 390, and by commanding the software module 340 to recommend an approved financial institution and an approved life insurance provider based on, for example, the information just entered for the newly accepted participating physician.

The software module 340 may then be commanded to set up a meeting (e.g., a date, a time, and a place) between the newly accepted participating physician and the recommended financial institution and the recommended life insurance provider, for example, in order for the participating physician to obtain a standby letter of credit and a life insurance policy to be held in the collateral account. In accordance with various aspects of the present invention, many other scenarios associated with the administered plan may be performed using the system 300 as well.

When a client leaves the administered plan, the ownership of the life insurance policy may be returned to the client, net of any outstanding unpaid obligations, in accordance with an embodiment of the present invention. As a result, the client may seek to receive the life insurance cash value and death benefit as an estate value upon retirement, for example.

An alternative to purchasing the life insurance component of the collateral account may be to arrange for a premium financing program to provide premium financed insurance to the participating clients. Clients with sufficient financial resources and collateral to credit can qualify for the financing program and finance premiums of between, for example, $10,000 per year to $100,000 per year.

Using deductibles within current medical malpractice policies available in, for example, the Ohio market should not require “discount” pricing to be offered by medical insurers, therefore, avoiding a problem where medical insurers might otherwise be undercutting their existing policies and pricing structure. Over time, based on experience rating of the participating physicians, more favorable pricing may be selectively offered by medical malpractice insurers operating within their defined profit margins. Additionally, the operating business entity may introduce, to participating physicians, professional programs designed to upgrade the practice procedures of the physicians so as to reduce the likelihood of medical malpractice litigation being successfully pursued.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method to reduce insurance premiums for a client participating in a plan administered by an operating business entity, said method comprising:
facilitating the establishment of a collateral account in the name of said client as part of said administered plan;
facilitating the purchasing of a first insurance policy, having a premium payment and a deductible, in the name of said client, wherein said first insurance policy is provided by an insurer approved by said operating business entity; and
facilitating the pledging of said collateral account to payment of said deductible in the event of a successful claim against said client which is covered by said first insurance policy.

2. The method of claim 1 further comprising facilitating the charging back of all or part of said deductible, to said client, if said deductible is paid from said collateral account.

3. The method of claim 1 wherein facilitating the establishment of said collateral account includes helping said client qualify for and obtain a standby letter of credit with a financial institution approved by said operating business entity.

4. The method of claim 1 wherein facilitating the establishment of said collateral account includes helping said client qualify for and purchase a second insurance policy, in the name of said client, having a cash value and a death benefit.

5. The method of claim 1 wherein said client comprises a licensed medical doctor.

6. The method of claim 1 wherein said first insurance policy comprises a medical malpractice insurance policy.

7. The method of claim 4 wherein said second insurance policy comprises a whole life insurance policy.

8. A method to establish a collateral account in the name of a client participating in a plan administered by an operating business entity, said method comprising:
obtaining a standby letter of credit from a financial institution in the name of said client;
purchasing a life insurance policy, in the name of said client, having a cash value and a death benefit; and
associating said standby letter of credit and said life insurance policy with a collateral account being in the name of said client and being pledged for payment of a deductible on a second insurance policy being in the name of said client.

9. The method of claim 8 wherein said client comprises a licensed medical doctor.

10. The method of claim 8 wherein said second insurance policy comprises a medical malpractice insurance policy.

11. A system to help administer a plan of an operating business entity to reduce insurance premiums, said system comprising:
a computer-based platform having at least one processor and at least one memory module;
first information being stored in said at least one memory module, wherein said first information is associated with at least one client participating in said administered plan;
second information being stored in said at least one memory module, wherein said second information is associated with at least one collateral account being in the name of said at least one client participating in said administered plan;
third information being stored in said at least one memory module, wherein said third information is associated with at least one insurer of a first type approved by said operating business entity; and
at least one software module being stored in said at least one memory module and being executed on said at least one processor to process at least said first, second, and third information as part of implementing at least one method associated with said administered plan.

12. The system of claim 11 further including fourth information being stored in said at least one memory module, wherein said fourth information is associated with at least one insurance provider of a second type approved by said operating business entity.

13. The system of claim 11 further including fifth information being stored in said at least one memory module, wherein said fifth information is associated with at least one financial institution approved by said operating business entity.

14. The system of claim 11 wherein said second information includes sixth information associated with at least one standby letter of credit being in the name of said at least one client and provided by at least one financial institution approved by said operating business entity.

15. The system of claim 11 wherein said second information includes seventh information associated with at least one life insurance policy being in the name of said at least one client and provided by at least one life insurance provider approved by said operating business entity.

16. The system of claim 11 wherein said client comprises a licensed medical doctor.

17. The system of claim 11 wherein said insurer of a first type comprises a medical malpractice insurer.

18. The system of claim 12 wherein said insurance provider of a second type comprises a life insurance provider.
